(19) United States
(12) Patent Application Publication
(10) Pub. No.: US 2026/0179900 A1
(43) Pub. Date: Jun. 25, 2026

(54) IMPRINTING AND RESIDUE FREE PATTERNED SUBSTRATES

(71) Applicant: LionVolt B.V., Eindhoven (NL)

(72) Inventors: Namdar KAZEMI, Eindhoven (NL); Sandeep UNNIKRISHNAN, Veldhoven (NL)

(21) Appl. No.: 19/472,603

(22) PCT Filed: Apr. 5, 2024
(86) PCT No.: PCT/NL2024/050173

§ 371 Date: Oct. 3, 2025

(30) Foreign Application Priority Data
Apr. 6, 2023 (NL) 2034517

(51) Int. Cl. H01M 4/04; H01M 4/66

(52) U.S. Cl. CPC H01M 4/0409; H01M 4/0404; H01M 4/661

(57) ABSTRACT

The present disclosure relates to a patterned substrate having a surface relief structure comprising a plurality of isolated and laterally separated elements of a cured polymer composition. The present disclosure further relates to a stamp, system, and methods of manufacturing. A method comprises: providing a stamp (10); depositing a flowable photocurable layer (50) onto a carrier substrate; imprinting the layer, by pressing (P) the stamp into the layer, selectively curing the photocurable layer while imprinting by providing a photonic exposure (L) onto the photocurable layer thereby forming the relief structure, and clearing uncured residues of the photocurable layer, if present, from the stamp and/or the carrier substrate, wherein the stamp protrusions comprise an opaque cap (13) that extends along a terminal end face (14) of the protrusions, and wherein the cap comprises a polymer or a composite, preferably an elastomer or elastomer composite.

### TECHNICAL FIELD AND BACKGROUND

The present disclosure relates to a patterned substrate, specifically a substrate having a relief structure formed thereon, wherein the relief structure comprises a plurality of isolated and laterally separated elements of a cured polymer composition. The present disclosure further relates to a stamp, system, and methods of manufacturing.

Substrates having a surface relief can be used in many fields. For example, in optics (as filters), or as scaffold for the assembly of functional multilayer structures, such as in 3D electrode.

Imprinting, for example thermal imprinting using a heated stamp in combination with pressure, is a known method that is employed to impart a negative of the stamp into a thermoplastic. Alternative imprinting methods include so-called forward and reverse nanoimprinting which typically providing a curable resist between a stamp and a substrate followed curing resist and removing the stamp.

KR20080098212A discloses a method involving a rigid coated stamp for providing a patterned substrate. An additional developing step is required to remove residues from the patterned substrate.

KR20090070946A concerns a method of reverse imprinting a resist for providing a patterned substrate. The process requires an inhibitor coat that is provided at specific positions between the substrate and the resist.

JP2010158805A describes an optical imprinting mold with a light shielding film at the tip of the convex portions of the mold. Etching with a developing solution is performed to remove uncured resin between the convex portions of the mold and substrate.

While the known processes can provide patterned substrate there remains a need for processes that are more robust, more durable, that involve less processing steps, and/or processes that yield substrates having less or even no residuals between adjacent relief elements. There also remains a need for processes in which any residuals that may be present between adjacent relief elements can be removed more easily, and/or without damaging the substrate.

### SUMMARY

Aspects of the present disclosure relate to a patterned substrate and to a method of manufacturing the patterned substrate that above desires.

The substrate comprises a carrier substrate having a relief structure formed thereon, wherein the relief structure comprises a plurality of isolated and laterally separated relief elements. The relief elements are formed of a cured composition, typically a polymer composition or a composite composition comprising a polymer matrix. The carrier substrate can be selected from a board range of substrates, including by not limited to polymer substrates, semiconductor substrates, metals substrates, composites, and multi-layer substrates. The cured relief can advantageously be used as a scaffold for one or more functional layers.

As will become clear from the specification herein below variations comprising an electrically conductive substrate, e.g. a metal, or metal coated substrate, can be of particular benefit in the manufacture of a current collector/current injector. For example, the substrate can provide an electrode (e.g. for a battery) providing a 3D patterned scaffold offering, among others, an increased area and/or current collecting capabilities and surface area for (battery) functional materials.

Advantageously the substrate can be a flexible or rollable substrate. In preferred embodiment, the carrier substrate comprises a flexible metal foil or a flexible foil with a metal coat, such as a copper foil or an aluminum foil or a metal coated plastic foil (e.g. PET or PEN). Alternatively, or in addition, the carrier substrate can be polymer film with optional additional layers deposited on it.

Advantageously, and particularly relevant for electrical applications, faces of the carrier substrate between the laterally separated protrusions can be directly accessible, or even essentially free of a coat or residues from the relief manufacturing process. Clearing of uncured residue from the faces of the carrier substrate between the laterally separated protrusions, if needed, can advantageously be done without damaging the carrier substrate and/or the laterally separated protrusions. Mitigating or even preventing a presence of layers/residues that obstructing direct electronically conductive contact with the substrate can improve performance, e.g. as current collector.

In a preferred embodiment, the substrate further comprises a metal top coat. The top coat can be disposed conformably onto the polymer scaffold and extend along faces of the carrier substrate between laterally separated protrusions. The coat increases the current collecting/injecting area and homogeneity of current collection.

In another or further preferred embodiment, the substrate can be, what is referred to herein as, a double side coated substrate. The double coated substrate can be used to advantage in stack applications and/or dual sided electrode applications, e.g. battery cell stacks. The double coated substrate, comprises an additional, second, relief structure that is formed along a face of the carrier substrate opposite the first relief structure. Referring to the methods for manufacturing a substrate as described below, the relief structures on opposite sides of a double side coated structure can be produced sequentially and/or on both sides simultaneously.

The substrate can be manufactured in a method, using materials and system as elaborated herein. Specifically, the methods/systems as described enable processing substrates under mild conditions, e.g. without a potential for contamination with developer and/or inhibitor residues as per KR20080098212A, KR20090070946A, and JP2010158805A. Additionally, the processes as described can mitigate or prevent substrate degradation/etching by eliminating a need for oxidants and/or etchants (e.g. strong acids or bases) to remove residues.

According to a further aspect there is provided a method of manufacturing a substrate comprising a carrier substrate having a relief structure, preferably the patterned substrate as disclosed herein. The method comprises at least a step of i) providing a stamp having a plurality of laterally separated upstanding stamp protrusions that extend from a stamp base. The stamp protrusions form a negative of the relief structure. In addition, the method comprises ii) a step of depositing a flowable photocurable layer onto the carrier substrate. The composition can be a photocurable resist as known in the field or a composite. Alternatively, or in addition, the composition can comprise a thermally curable composition. It will be understood that for thermally curable compositions curing can be triggered by heat, e.g. conductive or radiative (such as IR).

After providing the layer there is iii) a step of imprinting the photocurable layer. The imprinting comprises pressing the stamp into the layer to contact tips of the stamp protrusions with the carrier substrate thereby displacing flowable curable composition at positions between the substrate and tips of the stamp protrusions. By contacting the tips of the stamp protrusions with the carrier substrate, the majority or even substantially all of the flowable curable composition will be displaced from the space between tips of the stamp protrusion toward the recesses between adjacent stamp protrusions. Therefore, apart from very small amounts of residue, if any, there will be no flowable curable composition between the substrate and the tips of the stamp protrusions during curing. While the stamp is in contact with the layer there is a step of selectively curing the composition. The curing can comprise providing a photonic exposure onto the photocurable layer thereby forming the relief structure. Advantageously, the exposure can be provided through the stamp.

The stamp protrusions comprise an opaque cap that extends along a terminal end face at the tips of the stamp protrusions, and wherein the cap comprises a polymer or a composite, preferably an elastomer or elastomer composite. Providing an opaque cap can advantageously shield any material, if any, between stamp tips and the substrate from curing. Preferably, the base of stamp and the protrusions are formed of a flexible resilient composition.

The curing is be followed by v) a step of removing the stamp from the carrier substrate and the formed relief structure. The process steps (ii to v) can then be repeated on a different substrate or on a different section of the same substrate.

After removing the stamp there can be vi) a step of clearing uncured residues of the photocurable layer, if any, from the stamp and/or the carrier substrate. Since areas between the relief have been shielded from photocuring during the process residues, if any, can be conveniently removed without damaging the cured relief, e g. using a solvent exposure/washing step. If needed residues can be removed by alternate process, including by not limited to etching.

In addition to the method of manufacturing the patterned substrate described above, which can be referred to as forward imprinting, there is provided a further process that is based on reverse imprinting. The reverse imprinting based process and system as discussed herein advantageously provide an alternate route for the manufacturing of the substrate whereby a level of residues can be reduced using the same general concept as for forward imprinting. Alternatively or additionally, using reverse imprinting, a usage of curable composition can be reduced. Advantageously the stamp and processing system can be as described, and it will be appreciated that, unless indicated otherwise, further description of features may apply to both forward imprinting and reverse imprinting processes and systems. The method based on reverse imprinting comprises a) providing a stamp having a plurality of laterally separated upstanding stamp protrusions that extend from a face of a stamp base; b) a step of filling recesses between the laterally separated upstanding stamp protrusions with a flowable photocurable composition; c) a step of reverse imprinting the photocurable layer, the step comprising pressing the stamp onto the carrier substrate to contact the tips of the stamp protrusions with the carrier substrate, thereby contacting the flowable photocurable composition with the carrier substrate; d) a step of selectively curing the photocurable composition while reverse imprinting, the step comprising a photonic exposure through the stamp onto the photocurable composition thereby transferring the flowable photocurable composition from the recess and forming the relief structure; e) a step of removing the stamp from the carrier substrate and the formed relief structure, and f) a step of clearing uncured residues of the photocurable layer if present from the stamp and/or the carrier substrate. Similarly to the forward imprinting method, the stamp protrusions comprise an opaque cap that extends along a terminal end face at the tips of the stamp protrusions, and the cap comprises a polymer or a composite, preferably an elastomer or elastomer composite. Providing an opaque cap can advantageously shield any material, if any, between stamp tips and the substrate from curing. Preferably, the base of stamp and the protrusions are formed of a flexible resilient composition.

The combination of contacting the tips of the stamp protrusions with the carrier substrate and providing an opaque cap on the tips of the stamp protrusions (for both forward and reverse imprinting) is particularly advantageous for obtaining residue-free areas between the laterally separated protrusions, compared to processes where only one of these approaches is used. The inventors have found that if substantial amounts of curable composition are present between the tips of the protrusions and the carrier substrate (i.e., when the tips of the stamp protrusions are not brought in contact with the carrier substrate) photocuring of the material between the protrusion tips and substrate will still occur to a certain extent, even if stamp protrusions are provided with light shielding. This photocuring is caused by stray light that reaches the space between the tips of the stamp protrusions and the carrier substrate despite light shielding, for instance due to reflection of curing radiation by the carrier substrate, diffuse reflection from adjacent regions of the curable composition, and/or the light shielding not fully blocking the curing radiation. This inadvertent photocuring of material between stamp tips and substrate presents challenges for the removal of this “uncured” material (i.e., material that is inadvertently cured to a certain extent). Additional cleaning steps, and/or aggressive chemical processes such as etching may be needed for the removal, thereby increasing changes of damaging the cured relief and/or the carrier substrate.

In some embodiments, the cap is a of a composite comprising a polymer matrix with one or more additives to improve opacity, e.g. metal, ceramic particles or other particles (e.g. carbonaceous).

Because the stamp and cap are polymer based, or at least of a polymer based composition the stamp can, in contrast to rigid stamps, provided a more conformal contact with the substrate during the pressing on the substrate, by accommodating elastic deformation. In addition, and in further contrast to rigid stamps, the stamp according to the present disclosure can be more durable and/or be applied to comparatively more fragile/sensitive substrates.

In some embodiments, the cap is restricted to the end faces/tips of the protrusions. In other or further embodiments, the cap partially extends along a sidewall of the stamp protrusion. Partially coating sidewalls of the stamp protrusions was found to improve pattern definition, e.g. by blocking reflections/stray light.

In a preferred embodiment, the cap has a higher stiffness than the stamp protrusion. Alternatively, or in addition, the cap can have a higher hardness than the protrusion. Inventors find that when the stamp has comparatively lower stiffness and/or hardness than the cap, pattern definition can be further improved with even less or even no residues, for instance because of improved squeezing of curable composition away from under the cap. In addition, stress on the cap can be reduced, improving durability/operational lifetime.

In some preferred embodiments, the photocurable composition is heated prior to and/or during the imprinting, e.g. radiative (e.g. IR) or conductively. Heating the photocurable composition was found to increase pattern definition due to improved flowability (reduced viscosity) of the curable composition and to an increased speed of curing.

In some embodiments, the layer of the photocurable composition has a decreasing viscosity towards the carrier substrate. In this way, preferably in case of forward imprinting, material between stamp protrusions can be squeezed out more effectively. A viscosity gradient can be realized by depositing layers of photocurable compositions having different viscosity, e.g. a multilayer stack. Alternatively or additionally, a viscosity gradient with decreasing viscosity towards the carrier substrate can be achieved by applying a temperature gradient to the photocurable composition layer with increasing temperature towards the carrier substrate. Such a temperature gradient can for instance be achieved by heating the photocurable composition from the direction of the carrier substrate before and/or during imprinting.

Analogously, in some embodiments, the flowable photocurable composition between the stamp protrusions has an increasing viscosity towards the carrier substrate. In this way, preferably related to reverse imprinting, transferring of photocurable composition from the stamp to the carrier substrate can performed more effectively. A viscosity gradient can for instance be realized by filling the stamp recesses with layers of photocurable compositions having different viscosity, e.g. a multilayer stack. Alternatively or additionally, a viscosity gradient with increasing viscosity towards the carrier substrate can be achieved by applying a temperature gradient to the photocurable composition layer with decreasing temperature towards the carrier substrate. Such a temperature gradient can for instance be achieved by heating the photocurable composition from the direction of the stamp before and/or during imprinting.

In other or further embodiments, the steps under iii), iv) and optionally v), or in case of reverse imprinting the steps under c), d) and optionally e), are performed at sub-atmospheric pressure. Working at sub atmospheric pressure can improve stamp/substrate contact and reduce a content of volatiles in the curable composition (e.g. remove dissolved gas).

In some preferred variations the photocurable composition comprises an organic solvent, typically 1-10% by weight. Inventors find that addition of a solvent, preferably a volatile organic solvent, can advantageously induce a controllable amount of shrinkage during curing, which benefits stamp release.

The method/prosses steps as disclosed herein are not limited to rigid substrates (e.g. Si-wafers). Advantageously, the carrier substrate can be an elongate web, preferably a flexible metal foil or a flexible metal coated foil. Further, in case of forward imprinting, one or more, preferably all, of the steps of: depositing the flowable photocurable layer, imprinting the photocurable layer, selectively curing the photocurable layer, removing the stamp, and clearing uncured residues of the photocurable layer if present, can be embodied as a roll to roll process. Analogously, in case of reverse imprinting, one or more, preferably all, of the steps of: filling recesses with photocurable composition, reverse imprinting the photocurable composition, selectively curing the photocurable composition, removing the stamp, and clearing uncured residues of the photocurable layer if present, can be embodied as a roll to roll process.

In some variations, the method can further comprise step of coating the substrate with an adhesion promoting layer. Depending on the nature of the carrier substrate (e.g. type of metal) the adhesion promotion can be realized by one or more of: self-assembled monolayers (SAMs: including but not limited to silanes, thiols, etc. which can for instance be applied using CVD); a mild oxidation step (including but not limited to: UV/ozone, plasma, etc.); and deposition of metal and/or metal oxide (PVD, sputtering, etc.). It will be understood that, in cases wherein the patterned substrate is to be used in electrical applications (e.g. a current collector), the adhesion promoting layer is configured to provide an electrically conductive path to the substrate. In preferred variations the adhesion promoting layer includes a metal layer (e.g. a comparatively more noble metal than the carrier substrate, such as gold) or metal oxide (e.g. conductive metal oxides such as titanium nitride, zirconium nitride, and/or indium tin oxide), which can act as a barrier (e.g. an etch stop/sputter stop) during clearing uncured residues of the photocurable layer, if any.

In case the adhesion promoting layer is chemically inert toward the carrier substrate and is provided between the carrier substrate and the relief structure, the adhesion promoting layer can mitigate or even avoid reaction of the carrier substrate with the photocurable material of the relief structure, which could otherwise for instance lead to oxidation of the carrier substrate. In this respect, preferred materials for the adhesion promoting layer include ceramic materials such as titanium nitride, zirconium nitride, and/or indium tin oxide, or noble metals (e.g., gold).

According to a further aspect, there is provided is an electrode comprising the substrate comprising the carrier substrate and the relief structure as described herein. In case of an electrode, the carrier substrate is preferably electrically conductive such that it may act as a current collector. In addition to the substrate as described herein, the electrode may comprise additional layers on top of the substrate, such as an electrically conductive layer facilitating transport of electrons from the relief structure to the carrier substrate, a passivation layer preventing degradation of active electrode material, a seed layer for facilitating deposition of active electrode material, a host layer for active electrode material, and/or an SEI layer. The electrode may be an anode and/or a cathode. Advantageously, the lack of residue on the surface of the carrier substrate between upstanding protrusions allows good contact (e.g. electrical contact and/or mechanical contact) between the carrier substrate and any layer that may be deposited on the carrier substrate between protrusions of the relief structure.

Also provided is an energy storage device (e.g., a battery) comprising one or more electrodes as described above, and an electrolyte.

According to a further aspect there is provided a stamp for use in the method as disclosed herein. Unless otherwise clear from context the stamp comprises at least a stamp base having face provided with a plurality of laterally separated upstanding stamp protrusions, wherein the stamp is provided with one or more opaque caps that each extend along a terminal end face at a tip of a stamp protrusion, and wherein the cap is formed of polymer or composite, preferably an elastomer or elastomer composite. Preferably, the stamp base and the protrusions are optically transparent. This allows exposing the photocurable composition from a stamp direction during imprinting. Exposing the photocurable composition from a stamp direction allows using opaque substrates. For example, exposing from a stamp direction enables curing a layer of a photocurable composition on e.g. metal or metal coated foils with the stamp in flush contact.

Preferably, the stamp is formed of a flexible composition. This allows placing the stamp at the exterior of a roller for roll to roll processing. The stamp may for instance be provided at the exterior of a (single) roller, or suspended between two or more rollers, e.g. in the form of a belt. Advantages of providing the stamp as a belt suspended between two or more rollers compared to the exterior of a single roller include that it may allow more convenient scale-up of the process, and/or adjustment of the (forward and/or reverse) imprinting time. In addition, providing the stamp as a belt between two or more rollers may provide more space for additional equipment to be provided on the side of the stamp, for instance a heater, a radiation source for curing the photocurable composition, and/or a laser source for providing pulsed laser light.

In some variations the stamp comprises a metal or ceramic coat extending on top of the cap or between the cap and the stamp protrusion. The coat can reduce an optical transparence of the stamp at the tips.

In other or further variations an exterior surface of the cap is provided with a comparatively higher hydrophobicity (e.g. coating) than an exterior of the upstanding stamp protrusions. The comparatively higher hydrophobicity improves pattern definition and reduces a likelihood of residuals between tips and substrate. The hydrophobicity may be provided by selection of polymer type and/or additives, and/or by addition of monolayers (thiol in case of metal) silanes, etc.

According to a further aspect there is provided a method and system for manufacturing the stamp according to the present disclosure. The method comprising: providing a stamp base having a face provided with a plurality of laterally separated upstanding stamp protrusions, wherein the stamp base and the protrusions are optically transparent, coating a terminal end face at tips of the stamp protrusions with an opaque cap, wherein the coating comprises: steps providing a layer of curable ink composition having an opaque quality when cured onto an applicator and transferring at least part the ink to the tips, followed by, curing the ink.

The coating of the stamp tips can be by contacting the stamp to applicator, preferably an application roller, having a layer of the ink, preferably a layer having a pre-defined and well controlled thickness. Controlling a thickness can enable selective coating terminal end faces of the tip and/or partial coating of stamp protrusion sidewalls. Accordingly, in some embodiments, the method further comprises controlling a thickness of the layer at the applicator.

In some embodiments, the method further comprising one or more steps of depositing a ceramic or metal coat, prior to or after coating the ink. The coating can be provided by known means including but not limited to PVD or electro (less) plating

In a preferred variation the system configured to perform the method of manufacturing the stamp comprises: a source holding an amount of a curable ink composition having an opaque quality when cured; an applicator roller, and a receiver roller, disposed in a counter rotating relation with respect to the applicator roller, wherein the applicator roller is configured to receive from the source a film of the curable ink composition along an exterior surface of the applicator roller, and wherein the receiver roller is configured to carry along its exterior surface a stamp comprising a stamp base having a face provided with a plurality of laterally separated upstanding stamp protrusions, and wherein, the application roller and the receiver roller are mutually positioned such that the tips of the stamp protrusions contact the film of the curable ink composition.

In some embodiments, the system further comprises a substantially rigid ridge positioned at a controllable separation from exterior surface of the applicator roller forming a slit for controlling a thickness of the film of the curable ink composition.

According to a further aspect, there is provided a system configured to perform the method of manufacturing a substrate comprising a carrier substrate having a relief structure as described herein, the system comprising: an applicator; a stamp as described herein; a pressure system; and a curing system including a light source; wherein the applicator is configured for depositing a flowable photocurable layer onto the carrier substrate or for filling recesses between laterally separated upstanding stamp protrusions with a flowable photocurable composition; wherein the pressure system is configured to contact a tip of a stamp protrusion with the carrier substrate; and wherein the curing system is configured to provide a photonic exposure onto the photocurable layer or photocurable composition during imprinting.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A provides a method of manufacturing a substrate comprising a carrier substrate having a relief structure;

FIGS. 1B, 1C, and 1D illustrate various stages of the method shown in FIG. 1A;

FIG. 1E illustrates a patterned substrate;

FIG. 2 illustrates a stamp;

FIG. 3 illustrates a variation of the patterned substrate;

FIG. 4 illustrates an embodiment of flowable photocurable layer;

FIG. 5A depicts a system performing a method of manufacturing a patterned substrate;

FIG. 5B illustrates details of a variation of a system for performing a method of manufacturing a patterned substrate;

FIG. 5C illustrates details of a variation of a system for performing a method of manufacturing a patterned substrate;

FIG. 6 provides a method of manufacturing a stamp;

FIG. 7 illustrates a system during a process of manufacturing a stamp;

FIG. 8A illustrates a further method of manufacturing a substrate comprising a carrier substrate having a relief structure;

FIGS. 8B, 8C, and 8D illustrate various stages of the method shown in FIG. 8A;

FIG. 8E illustrates a patterned substrate; and

FIG. 9 illustrates a dual-sided patterned substrate.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

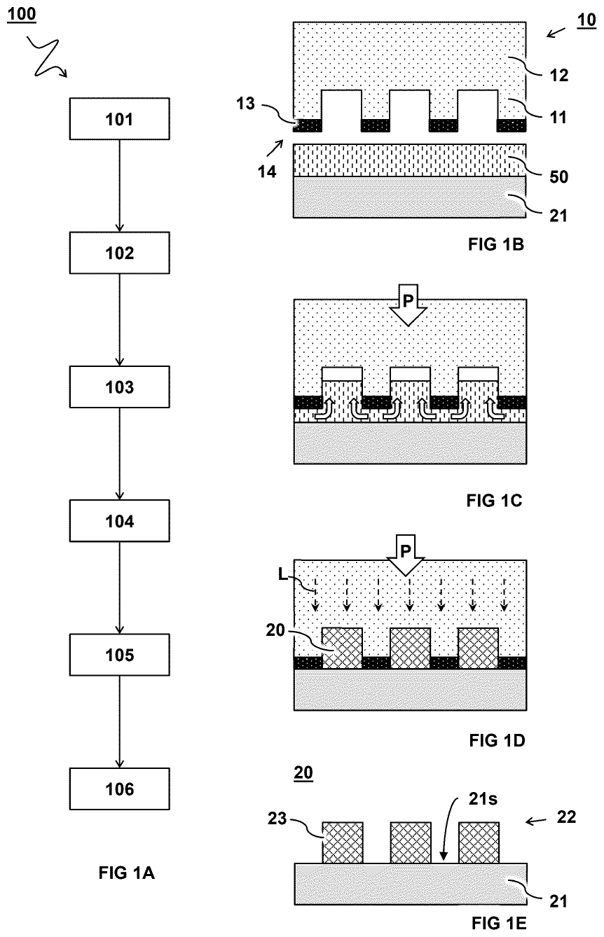

The patterned substrate, stamp, system, and methods of manufacturing will now be explained in further detail with reference to FIGS. 1-10. With reference to FIG. 1 there is provided a method (100) of manufacturing a substrate 20. In a variation the patterned substrate 20, comprises a carrier substrate 21 having a relief structure 22 formed thereon, wherein the relief structure comprises a plurality of isolated and laterally separated protrusions 23 formed of a cured polymer composition. Advantageously faces 29 of the carrier substrate between laterally separated protrusions can be essentially free of a coat or residues which, when present would obstruct a direct electronically conductive contact with the substrate.

As indicated the process can comprise:
a step of providing 101 a stamp;
a step of depositing 102 a flowable photocurable layer 50 onto the carrier substrate;
a step of imprinting 103 the photocurable layer;
a step of selectively curing (104) the photocurable layer while imprinting;
a step of removing (105) the stamp from the carrier substrate and the formed relief structure.

FIG. 1B illustrates a stamp 10 having a stamp base stamp base 12 and a plurality of stamp protrusions 11. The stamp protrusions are coated with opaque cap 13 which is limited to end faces of the stamp protrusions 11. In preferred embodiments, the cap has a transmissivity for the curing light of no more than 10% over a wavelength range (e.g. UV) triggering photo curing of the flowable photocurable layer 50. Such a cap may additionally be phobic (e.g. by monolayer coating or otherwise) to the photocurable polymer so that the latter is repelled away during imprinting leading to minimal or negligible residuals on the stamp. Preferably, the transmissivity is ≤5% or lower, e.g. fully reflective. Generally the stamp and the stamp protrusions 11 are formed of a polymer composition having a high transmissivity for the curing light. Typically, or preferably, the transmissivity of such polymer compositions is ≥80%, preferably ≥90%.

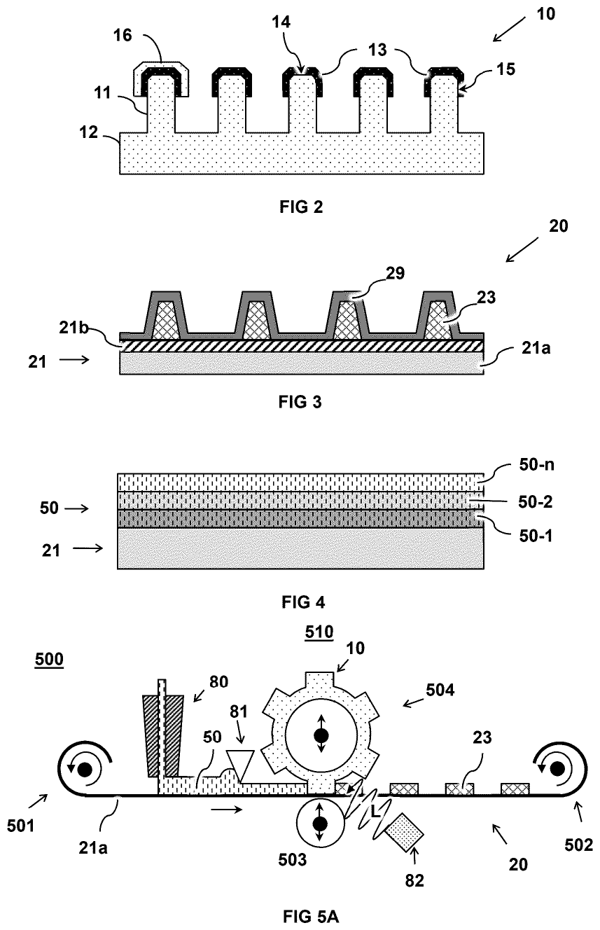

In a variation, e.g. as shown in FIG. 2, the stamp 10 can have one or more of tapered protrusions and a metal or ceramic coat 16 which can be provided onto of the opaque cap 13 or between the stamp protrusions 11 and the cap (not shown). Alternatively, or in addition, the cap the metal or ceramic coat 16 the stamp, can extend along the sidewall 15 of the stamp protrusions 11, e.g. over a length of up to 50% of a total height of the stamp protrusion 11. Both the additional coating and extension along sidewall the sidewall reduce transmissivity of the stamp protrusions 11 and increase pattern definition during the step of imprinting 103.

The flowable photocurable layer 50 has a thickness and/or flowability such that, upon imprinting, excess material between substrate and tips flows aside, e.g. into the space between adjacent stamp protrusions 11 when a pressure P is applied to the stamp, as indicated in FIG. 1C.

As indicated in FIG. 1D an amount of flowable photocurable layer 50 between substrate and stamp protrusions 11 can be negligible. Such that upon curing 104 the polymer relief is formed without residuals at faces 21s between adjacent relief structures. In case there is still some uncured residual photopolymer left on the faces 21s between adjacent relief structures (during the imprinting), it can be washed away after the imprinting.

As indicated in FIG. 1D the curing is performed during imprinting, that is with stamp protrusions 11 contacting the carrier substrate 21. Upon release of the stamp a substrate 20 is formed. As indicated the light (L) triggering the photo cure can be provided through the stamp, while in contact with the substrate, whereby the opaque cap 13 hinders/blocks exposure of curable material, if any, between the stamp protrusions 11 and the carrier substrate 21.

FIG. 1E illustrates an exemplary patterned substrate as obtained by the process. The patterned substrate 20 comprising a carrier substrate 21 having a relief structure 22 formed thereon, wherein the relief structure comprises a plurality of isolated and laterally separated relief elements 23 formed of a cured polymer composition, In a preferred embodiment (see e.g. FIG. 3), the carrier substrate 21 comprises a metal foil or a foil 21a with a metal coat 21b. Advantageously, faces of the carrier substrate 21s between laterally separated protrusions 23 can be free of a coat or residues obstructing a direct electronically conductive contact with the substrate

In some variations the method can include one or more steps of: clearing 106 uncured residues of the photocurable layer if present from the stamp and/or the carrier substrate; heating the photocurable layer prior to and/or during the imprinting; adding solvent to the flowable photocurable layer 50 prior to deposition; and a step of coating the substrate with an electrically conductive adhesion promoting layer or with an electrically conductive cover layer.

The substrate can be a multilayer substrate. FIG. 3 illustrates a variation wherein the substrate is a flexible polymer foil 21a having a metal coat 21, and wherein the formed relief is provided with a metal top coat 29.

In some embodiments the flowable photocurable layer 50 has a decreasing viscosity towards the carrier substrate to promote squeezing curable material from between the stamp protrusions 11 and the substrate. In some embodiments, e.g. as shown in FIG. 4, the flowable photocurable layer 50 is comprised of a multi-layer stack formed of sub layers (50-1,50-2,50-n), e.g. two, three, or more, with decreasing viscosity towards the substrate. For example, the sublayers can have progressively increasing levels of solvent. Alternatively or additionally, such a viscosity gradient can also be achieved by applying a temperature gradient to the photocurable layer with increasing temperature towards the carrier substrate, for instance by heating the photocurable composition from the direction of the carrier substrate before and/or during imprinting.

According to a further aspect there is provided a system 500 for manufacturing a patterned substrate 20 as disclosed herein. The system comprises at least the means configured to perform the method 100 of manufacturing substrate 20 comprising a carrier substrate 21 having a relief structure 22. In line with the method the system comprises at least:
a means of depositing a layer of flowable photocurable layer onto the carrier substrate;
a means of imprinting the photocurable layer, the means including a stamp as disclosed herein and a pressure system for pressing the stamp into the layer to contact the tips of the stamp protrusions with the carrier substrate thereby displacing the layer at positions between the substrate and tips of the stamp protrusions; and
a curing system including a light source for providing a photonic exposure (L) onto the photocurable layer, preferably from the direction of the stamp, thereby forming the relief structure.

Analogously, for reverse imprinting, there is provided a system 600 for manufacturing a patterned substrate 20 as disclosed herein. The system comprises at least the means configured to perform the method 400 of manufacturing substrate 20 comprising a carrier substrate 21 having a relief structure 22 as described herein. In line with the method the system comprises at least:
a means of filling recesses between laterally separated upstanding protrusions of a stamp as disclosed herein with a flowable photocurable composition;
a means of reverse imprinting a photocurable layer, the means including a stamp as disclosed herein and a pressure system for pressing the stamp onto the carrier substrate to contact the tips of the stamp protrusions with the carrier substrate, thereby contacting the flowable photocurable composition with the carrier substrate; and
a curing system including a light source for providing a photonic exposure (L) onto the photocurable composition, preferably from the direction of the stamp, thereby forming the relief structure.

In some preferred variation the system 500 or 600 comprises one or more of means for clearing uncured residues of the photocurable layer if present from the stamp and/or the carrier substrate; a heater system to heat the substrate and/or the photocurable material prior of an/or during imprinting, and a conveyor.

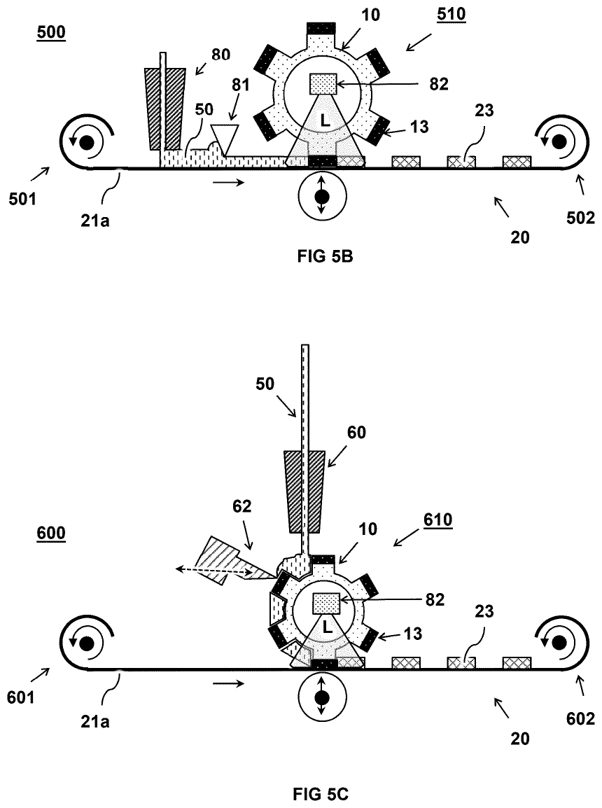

In preferred embodiments, the system 500 or 600 is embodied as a roll to roll system. FIG. 5A illustrates a system performing a method of manufacturing a patterned substrate using forward imprinting. The system includes a conveyor system, an applicator, and a patterning station 510. The conveyor system typically includes: a supply roller 501 holding a supply of the substrate 20 in the form of an elongate web 21a; a collection roller 502 for collecting the patterned substrate 20 after processing; and preferably one or more auxiliary rollers for guiding the web past processing positions including at least the applicator 80, e.g. a slot die coater, configured to apply a layer of flowable photocurable layer 50 and the patterning station 510. If needed one or more means to control a thickness of the flowable photocurable layer 50 can be provided (e.g. a flattening roller or a rigid ridge 81 disposed as a controllable separation from the substrate (cf. FIG. 7). In a preferred embodiment, e.g. as shown, the patterning station includes at least a patterning roller 504. The patterning roller holds along its external surface one or more of the stamp 10 as disclosed herein. A pressure system, for instance comprising a counter roller 503 (or otherwise, for instance a compressible plate or belt configured to press the substrate and the stamp towards each other) is provided such that tips of the stamp can be pressed into the photocurable layer 50. While in contact curing system 82 exposed the flowable photocurable layer 50 with light (UV in case of a UV curable composition).

Analogously, FIG. 5C shows a system for reverse imprinting (cf. method 400 described below), comprising a conveyor system, an applicator, and a patterning station 610. The conveyor system comprising supply roller 601 and collection roller 602 guides substrate 20 in the form of an elongate web 21a past patterning station 610. Applicator 60 is configured to fill the recesses between laterally separated upstanding protrusions of stamp 10, provided at the exterior surface of a roller, with flowable photocurable composition 50. A counter roller is provided such that stamp 10 can be pressed onto the carrier substrate to contact the tips of the stamp protrusions with the carrier substrate, thereby contacting the flowable photocurable composition 50 with the carrier substrate. While the tips of stamp 10 are in contact with the carrier substrate, curing system 82 exposes the flowable photocurable composition 50 to light (UV in case of a UV curable composition).

The system 600 may be provided with means to clean the tips of stamp protrusions prior to imprinting. Additionally, the system 600 may be provided with means to force and/or distribute flowable photocurable composition 50 into the recesses prior to imprinting. The means to clean the tips of stamp protrusions, and means to force/distribute flowable photocurable composition 50 into the recesses may be provided by separate components, or they can be combined. Preferably, such components are positionable at a controllable distance from the tips of the stamp protrusions. Suitable equipment to clean the tips of stamp protrusions and/or to force/distribute flowable photocurable composition 50 into the recesses may be rigid or flexible (e.g. a sponge or a squeegee), and may be provided as a moving element (e.g. a wiping roller) or as a stationary element. An example of a stationary element that can be used to force/distribute flowable photocurable composition 50 into the recesses and/or to clean tips of stamp protrusions is a rigid ridge 62 (e.g. a doctor blade) as shown in FIG. 5C. A combination of flexible element such as a squeegee to force/distribute flowable photocurable composition 50 into the recesses, followed by a rigid element such as a doctor blade to clean the tips of the protrusions is particularly provided.

In a strongly preferred embodiment, the curing system is integrated into the patterning station 510 or 610. Specifically, in a preferred variation the light source 82 is integrated in the patterning roller, e.g. as shown in FIGS. 5B and 5C. Integrating the light source in the patterning roller enables triggering curing the flowable photocurable layer 50 or photocurable composition 50 while imprinting whereby areas under/below the opaque cap 13 are shielded from exposure.

Preferably, the carrier substrate (21) is an elongate web (21a), preferably a flexible metal foil or a flexible metal coated foil, and the steps of: depositing the flowable photocurable layer depositing, imprinting the photocurable layer, selectively curing the photocurable layer, removing the stamp, and clearing uncured residues of the photocurable layer if present (or analogously for reverse imprinting the steps of filling recesses with photocurable composition, reverse imprinting the photocurable composition, selectively curing the photocurable composition, removing the stamp, and clearing uncured residues of the photocurable composition if present), are embodied along a roll to roll processing line (500 or 600).

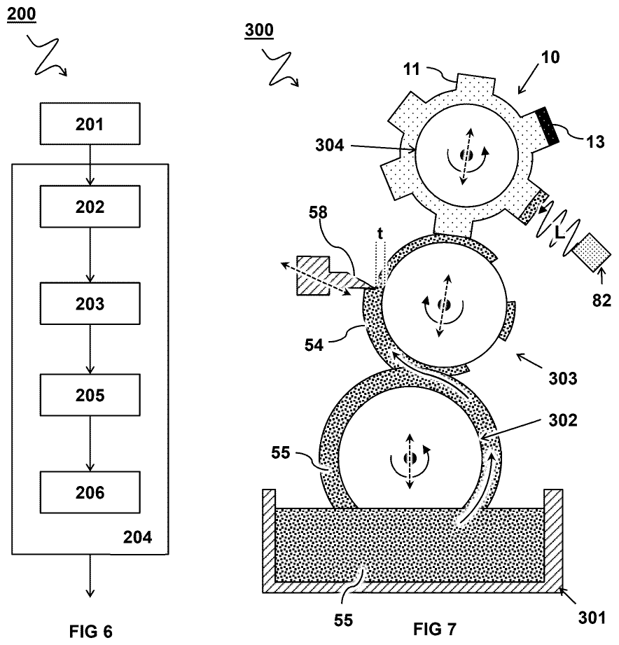

FIGS. 6 and 7 respectively illustrate a method 200 of manufacturing a stamp 10 and a system 300 configured to perform the method of manufacture the stamp as disclosed herein during operation.

As illustrated the method can comprise: providing 201 a stamp base having a face provided with a plurality of laterally separated upstanding stamp protrusions, wherein the stamp base and the protrusions are optically transparent; coating 204 a terminal end face at tips of the stamp protrusions with an opaque cap 13, wherein the coating comprises: a step of providing 202 a layer 54 of a curable ink composition 55 having an opaque quality when cured onto an applicator 303 and transferring 205 at least part the ink to the tips, followed by, curing 206 the ink.

The stamp base having a face provided with a plurality of laterally separated upstanding stamp protrusions, can be provided by conventional methods known in the art, e.g. from PDMS or rubber moulding.

The process can be suitably performed by the system 300 shown in FIG. 7. The system comprises a source (container 301), an applicator roller 303, and a receiver roller 304.

During operation, e.g. as shown, the receiver roller 304 carries along its external surface the stamp base having a face provided with a plurality of laterally separated upstanding stamp protrusions. An amount of ink having an opaque quality is transferred from container 301 to the tips of the stamp via application roller 303 by contacting the protrusions with the ink layer 54 carrier on the application roller. Once transferred the ink on the tips is cured (e.g. by light from source 82 as shown, or heat) to form the opaque cap 13. Once all tips are coated the stamp can be removed. Alternatively, the stamp be exposed to a further processing cycle to increase a thickness of the cap. To coat a portion of the stamp protrusions sidewalls (cf. FIG. 2) over a desired length the tips may be pressed into the layer 54 over a desired distance.

As shown the receiver roller is disposed in a counter rotating relation with respect to the applicator roller. The application roller and the receiver roller can be mutually positioned such that the tips of the stamp protrusions contact or extend into the film of the curable ink composition.

In a preferred embodiment, e.g. as shown, the system further comprises a substantially rigid ridge 58 positionable at a controllable separation from the exterior surface of the applicator roller forming a slit for controlling 203 a thickness of the film of the curable ink composition.

Similar as described in relation to the method or system of manufacturing the stamp the method and system of manufacturing the stamp can comprise means/steps for clearing uncured residues from one or more the rollers and/or stamp and/or means/steps for heating the uncured ink prior to or during stamp patterning.

In another or further preferred embodiment, e.g. as shown, the system can include one or more transfer rollers 302 configured to transfer ink from the container to the application roller. Inventors find that system comprising at least one transfer roller to transfer ink from the container to the application roller, preferably in combination with a means to control a thickness (t) of the film at the transfer roller (e.g. ridge 58) are particularly suitable to prevent coating the surfaces of the stamp base between the stamp protrusions 11.

In another aspect there is provided a further method of manufacturing a substrate comprising a carrier substrate having a relief structure. In contrast to the method discussed above with reference to FIGS. 1A-1E this method is based on so-called reverse imprinting. As opposed to forward imprinting in reverse imprinting the stamp, especially recesses between the stamp protrusions, is prefilled with the flowable photocurable composition after with the composition is transferred to the substrate. Prefilling the recesses and subsequent selective transfer of material to the substrate, as opposed to pressing the stamp into a predeposited layer on the substrate, is less limited by squeezing out excess composition between the substrates and tips of the stamp. Advantageously, prefilling of the stamp can be substantially limited to the recesses, leaving the stamp tips substantially free of flowable photocurable material.

Accordingly, there is provided a reverse-imprinting method for manufacturing a patterned substrate.

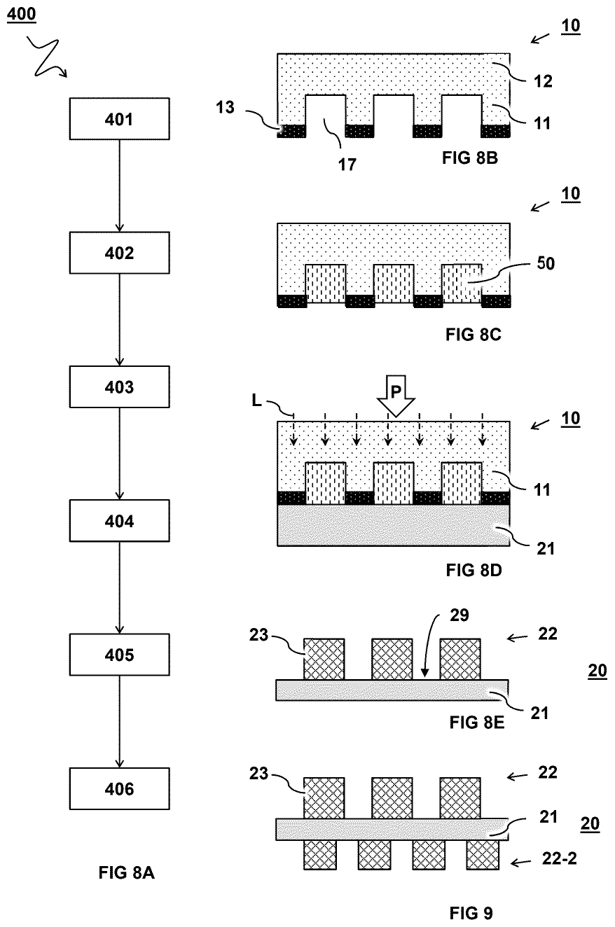

In some embodiments, e.g. as illustrated in FIG. 8A, the method comprises: a) providing 401 a stamp 10 having a plurality of laterally separated upstanding stamp protrusions 11 that extend from a face of a stamp base (12); b) a step of filling 402 recesses 17 between the laterally separated upstanding stamp protrusions with a flowable photocurable composition (50), c) a step of reverse imprinting 403 the photocurable layer, the step comprising pressing P the stamp 10 onto the carrier substrate to contact the tips of the stamp protrusions 11 with the carrier substrate 21, thereby contacting the flowable photocurable composition with the carrier substrate, d) a step of selectively curing 404 the photocurable composition while reverse imprinting (i.e., while the tips of the stamp protrusions 11 are in contact with the carrier substrate), the step comprising a photonic exposure through the stamp onto the photocurable composition thereby transferring the flowable photocurable composition from the recess and forming the relief structure, e) a step of removing 405 the stamp from the carrier substrate and the formed relief structure, and optionally f) a step of clearing (406) uncured residues of the photocurable layer if present from the stamp and/or the carrier substrate, wherein the stamp (see FIG. 8B) is provided with an opaque cap 13 that extends along a terminal end face at the tips of the stamp protrusions 11, and wherein the cap comprises a polymer or polymer composite, preferably an elastomer or elastomer composite.

Advantageously the stamp and the flowable photocurable composition, as well as other features as described above and shown for instance in FIGS. 2 and 3, can be substantially the same is described for the forward imprinting process as described in relation to FIG. 1.

The step of filling the recesses can be provided by means known in the field including but not limited to slot-die coating and doctor blading. In a preferred variation, the recesses can be filled by transferring photocurable composition from a predeposited layer. For example, by pressing the stamp (e.g. as provided on a carrier roller) onto a carrier substrate carrying a predeposited layer of flowable photocurable material 50. To minimize coating of the tips of the stamp protrusions, excess material may be removed, e.g. wiped off, for instance using ridge 62 shown in FIG. 5C. Alternatively, or in addition, an excess may be limited by setting a thickness of the predeposited layer in correspondence to an available volume within the stamp recesses. FIG. 8C illustrates a stamp after step 402 before 403, having its recesses filled with uncured photocurable composition 50. During step 403, as illustrated in FIG. 8D, the prefilled stamp is contacted with, i.e. pressed against, the carrier substrate 21. While in contact a curing is triggered by a photonic exposure (L) through the stamp. After curing and removal of the stamp a relief structure 22 is provided onto the substrate. As for the patterned substrate described in relation in FIG. 1E, faces 21s of the substrate between adjacent relief elements (23) can be free of residues.

In some embodiments related to reverse imprinting the flowable photocurable composition 50 has an increasing viscosity towards the carrier substrate, to promote transfer of photocurable composition from the stamp to the carrier substrate. Analogously to described above and shown in FIG. 4 for forward imprinting, a viscosity gradient can be realized using a photocurable composition 50 that is comprised of a multi-layer stack formed of sub layers (50-1,50-2,50-n), e.g. two, three, or more, with increasing viscosity towards the carrier substrate (i.e. opposite to the viscosity gradient that may be used in forward imprinting). Alternatively or additionally, such a viscosity gradient can also be achieved by applying a temperature gradient to the photocurable composition with decreasing temperature towards the carrier substrate, for instance by heating the photocurable composition from the direction of the stamp before and/or during imprinting.

Prior to and/or during step 404, pulsed laser radiation may be applied to the photocurable composition from the direction of the stamp. Advantageously, applying pulsed laser radiation, sometimes also referred to as Laser Induced Forward Transfer (LIFT), transfer of the photocurable composition from the stamp recesses onto the carrier substrate is facilitated by vaporizing a small amount of the photocurable composition, thereby pushing and accelerating the non-vaporized part of the photocurable composition towards the carrier substrate. Exact conditions such as laser wavelength and pulse duration may depend on factors such as the nature of the photocurable composition and dimensions of the recesses, and can be selected by the skilled person, for instance based on the information provided in Serra et al., Advanced Materials Technologies 2018, 4, 1800099.

Advantageously, in addition to facilitating transfer of the photocurable composition, the pulsed laser radiation may additionally cause the photocurable composition to cure to a certain extent, thereby facilitating shorter curing times.

For the purpose of clarity and a concise description, features are described herein as part of the same or separate embodiments, however, it will be appreciated that the scope of the invention may include embodiments having combinations of all or some of the features described.

For example, in some variations there is provided a patterned substrate, comprising a second relief structure formed along a face of the carrier substrate opposite the first relief structure. FIG. 9 (illustrates an exemplary substrate 21 having two mutually different surface reliefs 22,22-2 formed on either side. The dual-sided patterned substrate 20 shown in FIG. 9 can be of particular benefit in dual-sided electrode applications, e.g. in battery cell stacks.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. A method (100) of manufacturing a substrate (20) comprising a carrier substrate (21) having a relief structure (22), the method comprising:
i) providing (101) a stamp (10) having a plurality of laterally separated upstanding stamp protrusions (11) that extend from a stamp base (12),
ii) a step of depositing (102) a flowable photocurable layer (50) onto the carrier substrate
iii) a step of imprinting (103) the photocurable layer, the step comprising pressing (P) the stamp into the layer to contact a tip of the stamp protrusion with the carrier substrate thereby displacing the layer at positions between the substrate and tips of the stamp protrusions,
iv) a step of curing (104) the photocurable layer while imprinting, the step comprising providing a photonic exposure (L) onto the photocurable layer thereby forming the relief structure,
v) a step of removing (105) the stamp from the carrier substrate and the formed relief structure, and
vi) a step of clearing (106) uncured residues of the photocurable layer if present from the stamp and/or the carrier substrate,
wherein the stamp protrusions comprise an opaque cap (13) that extends along a terminal end face (14) of the stamp protrusions, and wherein the cap comprises a polymer or a composite,
preferably an elastomer or elastomer composite.

2. A method (400) of manufacturing a substrate (20) comprising a carrier substrate (21) having a relief structure (22), the method comprising:
a) providing (401) a stamp (10) having a plurality of laterally separated upstanding stamp protrusions (11) that extend from a face of a stamp base (12)
b) a step of filling (402) recesses (17) between the laterally separated upstanding stamp protrusions with a flowable photocurable composition (50),
c) a step of reverse imprinting (403) a photocurable layer, the step comprising pressing (P) the stamp (10) onto the carrier substrate thereby contacting the flowable photocurable composition with the carrier substrate,
d) a step of selectively curing (404) the photocurable composition while reverse imprinting, the step comprising a photonic exposure through the stamp onto the photocurable composition thereby transferring the flowable photocurable composition from the recess and forming the relief structure,
e) a step of removing (405) the stamp from the carrier substrate and the formed relief structure,
f) a step of clearing (406) uncured residues of the photocurable layer if present from the stamp and/or the carrier substrate,
wherein the stamp is provided with an opaque cap (13) that extends along a terminal end face at the tips of the stamp protrusions (11), and wherein the cap comprises a polymer or polymer composite, preferably an elastomer or elastomer composite.

3. The method according to claim 1 or 2, wherein the cap partially extends along a sidewall (15) of the stamp protrusion (11).

4. The method according to any of the preceding claims, wherein the cap has a higher stiffness than the stamp protrusion.

5. The method according to any of the preceding claims, wherein the deposited photocurable layer (50) or flowable photocurable composition in the recesses between the stamp protrusions is heated prior to and during the imprinting.

6. The method according to claim 5, wherein heating the deposited photocurable layer (50) is performed from the direction of the carrier substrate, such that the deposited photocurable layer (50) has an increasing temperature towards the carrier substrate.

7. The method according to any of claims 1, 3-6, wherein the flowable photocurable layer (50) has a decreasing viscosity towards the carrier substrate.

8. The method according to claim 5, wherein heating flowable photocurable composition in the recesses between the stamp protrusions is performed from the direction of the stamp, such that the flowable photocurable composition has a decreasing temperature towards the carrier substrate.

9. The method according to any of claims 2-5 and 8, wherein the flowable photocurable composition (50) in the recesses between the stamp protrusions has an increasing viscosity towards the carrier substrate.

10. The method according to any of the preceding claims, wherein the steps under iii), iv) and optionally v), or the steps under c), d) and optionally e) are performed at sub-atmospheric pressure.

11. The method according to any of the preceding claims, wherein the photocurable layer or the photocurable composition comprises 1-10 wt. % of an organic solvent.

12. The method according to any of the preceding claims, wherein the carrier substrate (21) is an elongate web (21a), preferably a flexible metal foil or a flexible metal coated foil, and wherein steps of:
depositing the flowable photocurable layer or filling the recesses with photocurable composition,
imprinting or reverse imprinting the photocurable layer,
curing the photocurable layer or the photocurable composition,
removing the stamp, and
clearing uncured residues of the photocurable layer if present, are embodied along a roll to roll processing line.

13. The method according to claim 12, wherein the stamp is provided at the exterior of a roller or as belt suspended between two or more rollers.

14. The method according to any of the preceding claims, wherein relief structures are formed on opposite faces of the carrier substrate.

15. The method according to any of the preceding claims, further comprising a step of coating the substrate with an electrically conductive adhesion promoting layer, whereby the adhesion promoting layer preferably includes a metal or metal oxide layer configured to act as an etch stop during the step of clearing (106, 406).

16. The method according to any of claims 2-5 and 8-15, further comprising a step of removing flowable photocurable composition from the tips of the stamp protrusions prior to the step of reverse imprinting.

17. The method according to any of claims 2-5 and 8-16, wherein prior to and/or during step d) of curing pulsed laser radiation is applied to the photocurable composition from the direction of the stamp.

18. A stamp (10) for use in the method according to any of claims 1-17, the stamp comprising a stamp base (12) having face provided with a plurality of laterally separated upstanding stamp protrusions (11), wherein the stamp base and the protrusions are optically transparent, and wherein the stamp is provided with opaque cap (13) that extends along a terminal end face at tips of the stamp protrusions, and wherein the cap is formed of polymer or composite, preferably an elastomer or elastomer composite.

19. The stamp according to claim 18, wherein the cap partially extends along a sidewall (15) of the stamp protrusion.

20. The stamp according to claim 18 or 19, wherein the cap has a higher stiffness, and optionally a higher hardness, than the stamp protrusion.

21. The stamp according to any of claims 18-20, further comprising a metal or ceramic coat (16) extending on top of the cap or between the cap and the stamp protrusion.

22. The stamp according to any of claims 18-21, wherein an exterior surface of the cap has a comparatively higher hydrophobicity than an exterior of the upstanding stamp protrusions.

23. A method (200) of manufacturing the stamp according to any of claims 19-22, the method comprising:
providing (201) a stamp base (12) having a face provided with a plurality of laterally separated upstanding stamp protrusions (11), wherein the stamp base and the protrusions are optically transparent,
coating (204) a terminal end face at tips of the stamp protrusions with an opaque cap (13),
wherein the coating comprises:
a step of providing a layer (54) of a curable ink composition (55) having an opaque quality when cured onto an applicator and transferring the ink to the tips, followed by,
curing (206) the ink.

24. The method according to claim 23 further comprising controlling (203) a thickness of the layer (54) at the applicator.

25. The method according to claim 23 or 24, further comprising a step of depositing a ceramic or metal coat.

26. A system (300) configured to perform the method (200) according to any of claims 23-25 to manufacture of the stamp (10) according to any of claims 18-22, the system comprising:
a source (301) for holding an amount of a curable ink composition (55) having an opaque quality when cured,
an applicator roller (303), and
a receiver roller (304), disposed in a counter rotating relation with respect to the applicator roller, wherein
the applicator roller is configured to, in use, receive from the source a film of the curable ink composition (55) along an exterior surface of the applicator roller, and wherein
the receiver roller is configured to, in use, carry along its exterior surface a stamp (10) comprising a stamp base having a face provided with a plurality of laterally separated upstanding stamp protrusions, and wherein,
the application roller and the receiver roller are mutually positionable such that the tips of the stamp protrusions contact the film of the curable ink composition.

27. The system according to claim 26, further comprising a substantially rigid ridge (58) positioned at a controllable separation from exterior surface of the applicator roller forming a slit for controlling a thickness of the film of the curable ink composition.

28. A system (500,600) configured to perform the method (100,400) of manufacturing a substrate (20) comprising a carrier substrate (21) having a relief structure (22) according to any of claims 1-17, the system comprising:
an applicator (60,80);
a stamp (10) according to any one of claims 18-22;
a pressure system; and
a curing system (82) including a light source;
wherein the applicator is configured for depositing (102) a flowable photocurable layer (50) onto the carrier substrate or for filling (402) recesses (17) between laterally separated upstanding stamp protrusions with a flowable photocurable composition (50);
wherein the pressure system is configured to contact a tip of a stamp protrusion with the carrier substrate; and
wherein the curing system is configured to provide a photonic exposure (L) onto the photocurable layer or photocurable composition (50) during imprinting (103,403).

29. A substrate (20), preferably obtained by the method according to and of claims 1-17 using the stamp (10) according to any of claims 18-22, comprising a carrier substrate (21) having a relief structure (22) formed thereon, wherein the relief structure comprises a plurality of isolated and laterally separated relief elements (23) formed of a cured polymer composition, wherein the carrier substrate (21) comprises a metal foil or a foil (21a) with a metal coat (21b), and wherein faces of the carrier substrate between laterally separated protrusions are free of a coat or residues obstructing a direct electronically conductive contact with the substrate.

30. The substrate according to claim 29, further comprising a metal top coat (29) disposed onto faces of the carrier substrate between laterally separated protrusions and conformably extending along the laterally separated relief elements.

31. The substrate according to claim 29 or 30, comprising a second relief structure (22-2) formed along a face of the carrier substrate opposite the first relief structure.

32. A battery electrode comprising the substrate according to any of claims 29-31.

33. An energy storage device comprising one or more electrodes according to claim 32, and an electrolyte.
